(19) United States
(12) Patent Application Publication
(10) Pub. No.: US 2025/0104915 A1
(43) Pub. Date: Mar. 27, 2025

(54) RELEASE FILM AND METHOD FOR MANUFACTURING MULTILAYER ELECTRONIC COMPONENT USING THE SAME

(71) Applicant: SAMSUNG ELECTRO-MECHANICS CO., LTD., Suwon-si (KR)

(72) Inventors: Dae Jin SHIM, Suwon-si (KR); Jung Jin PARK, Suwon-si (KR); Jung Jin PARK, Suwon-si (KR); Jae Won KIM, Suwon-si (KR); Hyo Sung CHOI, Suwon-si (KR); Nam Ju YOO, Suwon-si (KR); Jung Hee KIM, Suwon-si (KR); Jong Ho LEE, Suwon-si (KR)

(73) Assignee: SAMSUNG ELECTRO-MECHANICS CO., LTD., Suwon-si (KR)

(21) Appl. No.: 18/733,071

(22) Filed: Jun. 4, 2024

(30) Foreign Application Priority Data
Sep. 21, 2023 (KR) 10-2023-0126599

(51) Int. Cl. H01G 4/008; C04B 37/00; C04B 41/45; C04B 41/51; C08K 5/42; C09D 5/16; C09D 7/63; C09D 183/08; H01G 4/12; H01G 4/30

(52) U.S. Cl. CPC H01G 4/0085; C04B 37/001; C04B 41/4578; C04B 41/51; C09D 5/1675; C09D 7/63; C09D 183/08; C04B 2237/68; C08K 5/42; H01G 4/12; H01G 4/30

(57) ABSTRACT

A release film including: a base film; and a release layer disposed on one surface of the base film, wherein the release layer is a cured layer of a release composition including a heterocyclic compound including nitrogen and polydimethylsiloxane, and when analyzing a surface using X-ray photoelectron spectroscopy (XPS), the release layer has an atomic ratio of nitrogen (N) to silicon (Si) (N/Si) of 0.6 to 1.1.

### CROSS-REFERENCE TO RELATED APPLICATION(S)

This application claims benefit of priority to Korean Patent Application No. 10-2023-0126599 filed on Sep. 21, 2023, in the Korean Intellectual Property Office, the disclosure of which is incorporated herein by reference in its entirety.

### TECHNICAL FIELD

The present disclosure relates to a release film and a method for manufacturing a multilayer electronic component using the same.

In general, a release film obtained by utilizing a polyester film as a base material and stacking a release layer thereon is used to form a ceramic green sheet used in manufacturing a multilayer electronic component, for example, a multilayer ceramic capacitor (hereinafter referred to as ‘MLCC’).

Meanwhile, after forming a ceramic green sheet by applying and drying a ceramic slurry on a release film for manufacturing an MLCC, problems such as poor peeling may occur due to static electricity generated when separating the ceramic green sheet from the release film. Accordingly, the problem of decreased yield due to defects and short circuits in an MLCC, a finished product, is increasing.

In order to solve this problem, research is required on a release film having a release layer mainly formed of non-silicon components, rather than a release layer mainly formed of conventional polymer silicon.

### SUMMARY

An aspect of the present disclosure is to provide a release film that may form a ceramic green sheet with fewer defects due to lower peeling force and electrostatic force generated during peeling.

However, the aspects of the present disclosure are not limited to the above-described contents, and may be more easily understood in the process of describing specific embodiments of the present disclosure.

According to an aspect of the present disclosure, a release film includes: a base film; and a release layer disposed on a first surface of the base film, wherein the release layer includes a cured product of a release composition including a heterocyclic compound including nitrogen and polydimethylsiloxane, and, when analyzing a surface of the release layer using X-ray photoelectron spectroscopy (XPS), the release layer has an atomic ratio of nitrogen (N) to silicon (Si) (N/Si) of 0.6 to 1.1.

An effect of the present disclosure is to provide a release film that may form a ceramic green sheet with fewer defects due to lower peeling force and electrostatic force generated during peeling.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a cross-sectional view schematically illustrating a release film according to an example embodiment of the present disclosure;

FIG. 2 is a cross-sectional view schematically illustrating a state in which a ceramic green sheet is formed on the release film according to the example embodiment illustrated in FIG. 1; and

FIG. 3 is a cross-sectional view schematically illustrating a multilayer electronic component manufactured using a release film according to an example embodiment of the present disclosure.

### DETAILED DESCRIPTION

Hereinafter, embodiments of the present disclosure will be described with reference to specific example embodiments and the attached drawings. The embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

Furthermore, throughout the specification, “-based compound,” “-based resin,” “-based polymer,” “-based polymer,” and “-based copolymer” are broad concepts that include “˜ compound,” “˜ resin,” “˜ polymer,” “˜ polymer,” “˜ copolymer,” or/and their derivatives.

In the drawings, a first direction may be defined as a thickness (T) direction, a second direction may be defined as a length (L) direction, and a third direction may be defined as a width (W) direction.

### Release Film

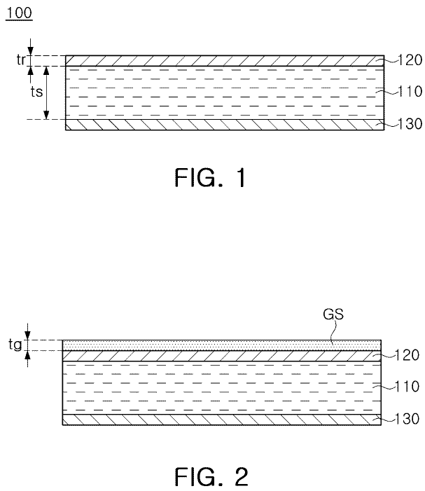

FIG. 1 is a cross-sectional view schematically illustrating a release film according to an example embodiment of the present disclosure. FIG. 2 is a cross-sectional view schematically illustrating a state in which a ceramic green sheet is formed on the release film according to the example embodiment illustrated in FIG. 1.

A release film 100 according to an example embodiment of the present disclosure may include a base film 110 and a release layer 120 disposed on the base film 110, and the release layer 120 may be a cured layer of a release composition including a heterocyclic compound including nitrogen and polydimethylsiloxane, and when a surface of the release layer 120 is analyzed using X-ray photoelectron spectroscopy (XPS), an atomic ratio of nitrogen (N) to silicon (Si) (N/Si) may be 0.6 to 1.1.

### 1. Base Film

The base film 110 constituting the release film 100 according to an example embodiment of the present disclosure may use a known film widely used in the field of conventional release films, and the type of base film 110 is not particularly limited.

The base film 110 may include a polyester-based compound or a polyester-based polymer, and may be, for example, a case in which a main repeating unit is at least one selected from ethylene terephthalate and ethylene naphthalate. As an example, the base film 110 may include poly(ethylene terephthalate) (PET), which is formed by condensation polymerization of ethylene glycol and terephthalic acid. In this case, polyethylene terephthalate may be produced using a direct method using terephthalic acid described above, but the present disclosure is not limited thereto.

Additionally, in consideration of heat and chemical resistance, mechanical strength, and economic efficiency, polyethylene terephthalate may be used as the base film 110, and more specifically, a uniaxially or biaxially stretched polyethylene terephthalate film may be used.

Additionally, in order to improve the slipperiness of the release film 100, the base film 110 may include one or more particles of silica, silicon oxide, calcium carbonate, calcium sulfate, calcium phosphate, magnesium carbonate, magnesium phosphate, barium carbonate, kaolin, aluminum oxide and titanium oxide, but the present disclosure is not limited thereto.

A thickness (ts) of the base film 110 may be, for example, 10 μm to 200 μm, but the present disclosure is not limited thereto.

### 2. Release Layer

The release layer 120 according to an example embodiment of the present disclosure may be disposed on one surface of the base film 110. The release layer 120 may be a cured layer of a release composition including a heterocyclic compound including nitrogen and polydimethylsiloxane.

### (Heterocyclic Compound)

A heterocyclic compound included in the release composition may be a main component of the release layer 120. The heterocyclic compound may enable the release layer to have a high elastic modulus so that a winding process of a release film (a process of winding the release film into a roll) may be performed smoothly. Additionally, the heterocyclic compound may improve the applicability of the release composition to the base film by allowing the release composition to have high surface energy.

The heterocyclic compound included in the release composition may include nitrogen, and the heterocyclic compound including nitrogen may include one or more of melamine, ammeline, melam, and melem. In an example embodiment, the heterocyclic compound including nitrogen may include one or more of ammeline, melam, and melem.

The heterocyclic compound may include, for example, one or more of methoxymethyl melamine, ethoxymethyl melamine, propoxymethyl melamine, butoxymethyl melamine, hexamethoxymethyl melamine, hexaethoxymethyl melamine, hexapropoxymethyl melamine, hexabutoxymethyl melamine, hexapentyloxymethyl melamine, and hexahexyloxymethyl melamine, but the present disclosure is not limited thereto.

The heterocyclic compound may include, for example, one or more of the compounds represented by the following formulas 1 to 4. In an example embodiment, a heterocyclic compound may include one or more of the compounds represented by Formulas 2 to 4 below.

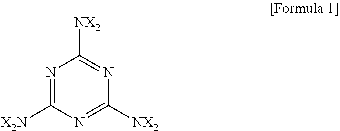

(Here, X represents a hydrogen atom, —CH₂OH, or —CH₂—O—R, each X may be identical or different. R represents an alkyl group having 1 to 8 carbon atoms. When a plurality of R is present, each R may be identical or different.)

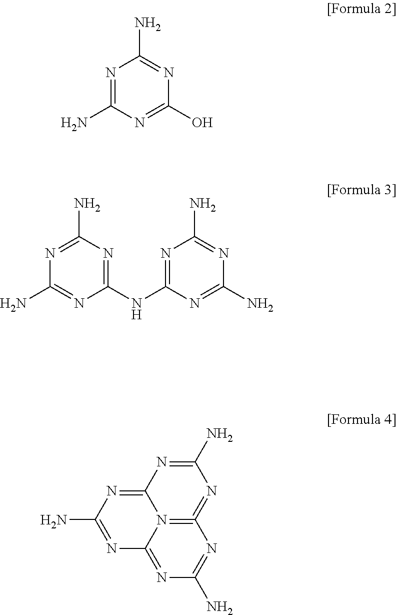

### (Polydimethylsiloxane)

Polydimethylsiloxane contained in the release composition is an additive to impart release properties to the release layer, and may be coupled to a melamine-based compound, which is a release composition, thereby improving the durability of the release layer.

Meanwhile, polydimethylsiloxane included in the release composition may have, more preferably, a functional group. The functional group may be introduced at one end or both ends of polydimethylsiloxane, and there may be one or more position at which the functional group is introduced.

Polydimethylsiloxane has functional groups such as a cyclic ether group, a hydroxy group, a mercapto group, a carboxyl group, a methacryloyl group, an acryloyl group, a polyether group, an alkyl group, a fluoroalkyl group, a long-chain alkyl group, an ester group, an amide group, a phenyl group, a vinyl group, and/or a hexenyl group, and polydimethylsiloxane may have, preferably, a hydroxy group at both ends for bonding with a heterocyclic compound, but the present disclosure is not limited thereto.

There is no need to specifically limit a content of polydimethylsiloxane included in the release composition, and may be 3 parts by weight or more and 25 parts by weight or less based on a total of 100 parts by weight of the heterocyclic compound and polydimethylsiloxane.

There is no need to specifically limit a weight average molecular weight of the polydimethylsiloxane included in the release composition, and may be 1000 or more and 500,000 or less. When the weight average molecular weight of polydimethylsiloxane is less than 1000, peelability of the release film may decrease, and when the weight average molecular weight of polydimethylsiloxane is more than 500,000, viscosity of the release composition may become significantly high, which may reduce the planarity of the release layer.

### (Acid Catalyst)

In an example embodiment, the release composition may further include an acid catalyst in addition to the above-described components. The acid catalyst may serve to promote a crosslinking reaction with the heterocyclic compound included in the release composition.

The acid catalyst may include, for example, one or more of methanesulfonic acid, trifluoromethanesulfonic acid, isoprenesulfonic acid, camphorsulfonic acid, hexanesulfonic acid, octanesulfonic acid, nonanesulfonic acid, decanesulfonic acid, hexadecanesulfonic acid, dinoylnaphthalenesulfonic acid, dinonylnaphthalenedisulfonic acid, benzenesulfonic acid, alkylbenzenesulfonic acid, para-toluenesulfonic acid, melamine trisulfonic acid (MTSA), cumenesulfonic acid, dodecylbenzenesulfonic acid, naphthalenesulfonic acid, and nonylnaphthalenesulfonic acid, and from the viewpoint of reactivity with a heterocyclic compound, the release composition may include, preferably, paratoluenesulfonic acid.

The amount of acid catalyst added may be preferably 0.1 to 10 parts by weight based on 100 parts by weight of the heterocyclic compound. When the content of the acid catalyst is less than 0.1 part by weight as compared to 100 parts by weight of the heterocyclic compound, a curing reaction may be delayed, and when the amount thereof exceeds 10 parts by weight based on 100 parts by weight of the heterocyclic compound, the storage stability of the release composition may decrease.

### (Solvents and Other Ingredients)

In an example embodiment, the release composition may further include a binder, a conductivity improver, a pH adjuster, and a surfactant, in a range that does not change the properties of the release layer, and may include residual amounts of solvent.

Any solvent may be used as long as it is compatible with the heterocyclic compound. Examples of the solvent may include one or more of acetone, methyl ethyl ketone, methyl isobutyl ketone, cyclohexanone, toluene, xylene, methanol, ethanol, butanol, isopropyl alcohol, isobutyl alcohol, ethyl acetate, butyl acetate, propyl acetate, isopropylacetate, hexane, heptane, octane, and isooctane.

### (Characteristics of Release Layer)

According to an example embodiment of the present disclosure, when analyzing a surface of the release layer 120 using X-ray Photoelectron Spectroscopy (XPS), an atomic ratio of nitrogen (N) to silicon (Si) (N/Si) may be 0.6 to 1.1. Other methods and/or tools appreciated by one of ordinary skill in the art, even if not described in the present disclosure, may also be used. When the atomic ratio of nitrogen to silicon (N/Si) deviates from the aforementioned range, the release properties of the release film 100 may decrease, which may cause problems in which the ceramic green sheet may not be peeled off smoothly, resulting in sheet wrinkling defects or burnt defects.

Specifically, when the atomic ratio of nitrogen to silicon (N/Si) is less than 0.6, the applicability and formability of the release composition may decrease, resulting in sheet wrinkle defects or burnt defects. Additionally, when the atomic ratio of nitrogen to silicon (N/Si) is greater than 1.1, peeling force when peeling the ceramic green sheet from the release film increases, and as a result, sheet wrinkle defects or burnt defects may occur.

Nitrogen (N) detected during XPS analysis on the surface of the release layer 120 may be derived from a heterocyclic compound including nitrogen, and silicon (Si) detected during XPS analysis may be derived from polydimethylsiloxane. The atomic ratio of nitrogen to silicon (N/Si) may be adjusted, for example, by the content or type of heterocyclic compound and polydimethylsiloxane, but the present disclosure is not limited thereto.

In an example embodiment, a content of the nitrogen (N) element among all elements included in the release layer 120 may be 11.0 wt % or more and 21.1 wt % or less. The content of a nitrogen (N) element included in the release layer 120 may be determined by the content of the heterocyclic compound included in the release composition. When the content of the nitrogen (N) element included in the release layer 120 deviates from the aforementioned range, the release properties of the release film 100 may decrease, resulting in sheet wrinkle defects or burn defects.

In an example embodiment. A maximum height roughness (Rmax) of the release layer 120 may be 70 nm or less. When the maximum height roughness (Rmax) of the release layer 120 is 70 nm or less, the release layer 120 may exhibit high smoothness. As a result, when forming the ceramic green sheet GS on the release layer 120, an occurrence of defects such as pinholes may be suppressed.

In this application, the maximum height roughness (Rmax) of the release layer 120 may be measured based on the ISO 25178 (Geometric Product Specifications (GPS)-Surface texture: areal) standard. The maximum height roughness (Rmax) of the release layer 120 may be measured using, for example, a three-dimensional contact surface roughness measuring device. More specifically, the maximum height roughness (Rmax) of the release layer 120 may be calculated as a distance between two parallel lines that are parallel to a center of the cross-section curve and are in contact with the highest peak and deepest valley by obtaining a reference length from a cross-section curve through the surface roughness measuring device. Other methods and/or tools appreciated by one of ordinary skill in the art, even if not described in the present disclosure, may also be used.

A lower limit of the maximum height roughness (Rmax) of the release layer 120 is not particularly limited and may be greater than 0 nm.

In an example embodiment, a ratio (tr/ts) of a thickness (tr) of the release layer 120 to a thickness (ts) of the base film 110 may be 0.005 or more and 0.027 or less. When a tr/ts value is less than 0.005, the surface roughness characteristics of the release layer 120 may decrease. Additionally, when the tr/ts value is greater than 0.027, peeling force generated when peeling the ceramic green sheet GS from the release film 100 may increase excessively.

Here, the thickness (tr) of the release layer 120 refers to a thickness after drying and curing of the release composition are completed. The thickness (ts) of the base film 110 and the thickness (tr) of the release layer 120 may be measured by observing a cross section of the release film 100 with a scanning electron microscope (SEM). Other methods and/or tools appreciated by one of ordinary skill in the art, even if not described in the present disclosure, may also be used.

In an example embodiment, the surface energy of the release layer 120 may be 28 mN/m or more and 30 mN/m or less. The surface energy may be measured by the method disclosed herein. Other methods and/or tools appreciated by one of ordinary skill in the art, even if not described in the present disclosure, may be used. The surface energy of the release layer 120 is related to the applicability of the ceramic slurry applied to the release layer 120 and peeling force of the release layer 120. Specifically, as the surface energy of the release layer 120 increases, the applicability of the ceramic slurry applied to the release layer 120 may be improved, and as the surface energy of the release layer 120 is lower, the peelability of the release film 100 may be improved.

That is, when the surface energy of the release layer 120 is less than 28 mN/m, wettability and smoothness may be reduced when a ceramic slurry is applied to the release layer 120. Additionally, when the surface energy of the release layer 120 is greater than 30 mN/m, the peeling force of the release film 100 may become excessively high.

### 3. Antistatic Layer

In an example embodiment, an antistatic layer 130 may be further disposed on the other side opposing one surface of the base film 110 on which the release layer 120 is disposed. An antistatic composition forming the antistatic layer 130 may include antistatic particles and a binder.

The antistatic particles included in the antistatic composition may be, for example, a conductive polymer resin, and may include polythiophene, polypyrrole, polyaniline, polyethylenedioxythiophene (PEDOT), or mixtures thereof, but the present disclosure is not limited thereto.

The binder included in the antistatic composition may be, for example, a polyester-based binder, but the present disclosure is not limited thereto.

### Method for Manufacturing Multilayer Electronic Component

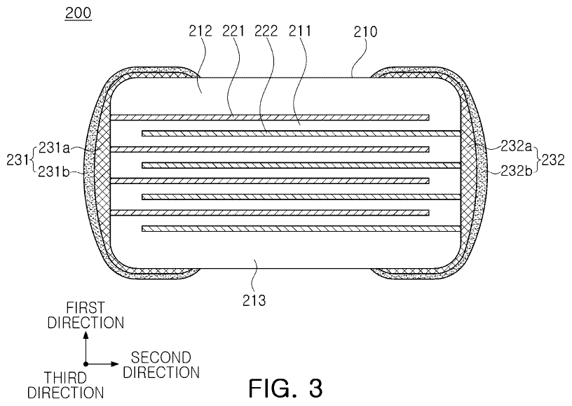

FIG. 3 is a cross-sectional view schematically illustrating a multilayer electronic component 200 manufactured using a release film according to an example embodiment of the present disclosure.

The multilayer electronic component 200 may include a body 210 including a dielectric layer 211 and internal electrodes 221 and 222, and external electrodes 231 and 232 disposed outside the body 210 and connected to the internal electrodes 221 and 222. More specifically, the multilayer electronic component 200 may include a first external electrode 231 connected to a first internal electrode 221, and a second external electrode 232 connected to a second internal electrode 222.

Additionally, the body 210 may include a capacitance forming portion in which capacitance is formed by including the first and second internal electrodes 221 and 222 alternately disposed with a dielectric layer 211 therebetween, and cover portions 212 and 213 disposed on both surfaces of the capacitance forming portion opposing each other in a first direction.

Hereinafter, an example of a method for manufacturing a multilayer electronic component 200 using a release film 100 according to an example embodiment of the present disclosure will be described. The release film 100 according to an example embodiment of the present disclosure described above may be used as a carrier film for forming a ceramic green sheet.

First, ceramic powder particles may be prepared to form the dielectric layer 211. The ceramic powder particles are not particularly limited as long as sufficient electrostatic capacitance may be obtained therewith, but for example, barium lead composite perovskite-based materials, or strontium titanate-based materials may be used. Examples of the ceramic powder particles may be BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) in which is formed by partially employing calcium (Ca) and zirconium (Zr) in BaTiO₃, or Ba(Ti_{1-y}Zr_{y})O₃ (0<y<1). Among the ceramic powder particles, BaTiO₃ may be synthesized, for example, by reacting titanium raw materials such as titanium dioxide with barium raw materials such as barium carbonate. Examples of a method for synthesizing ceramic powder particles may include a solid phase method, a sol-gel method, and a hydrothermal synthesis method, but the present disclosure is not limited thereto.

Next, a ceramic slurry may be manufactured by mixing ceramic powder particles, an organic solvent such as ethanol, and a binder such as polyvinyl butyral. Then, the ceramic slurry may be applied and dried on the release film 100 according to an example embodiment of the present disclosure to form a ceramic green sheet GS. An average thickness (tg) of the ceramic green sheet GS is not particularly limited, but may be, for example, 0.5 μm to 5.0 μm. The thickness may be measured by observing the ceramic green sheet GS with a scanning electron microscope (SEM). Other methods and/or tools appreciated by one of ordinary skill in the art, even if not described in the present disclosure, may also be used.

In an example embodiment, the maximum height roughness (Rmax) of the ceramic green sheet GS may be 53 nm or less. By forming the ceramic green sheet using the release film 100 according to an example embodiment of the present disclosure, the maximum height roughness (Rmax) of the ceramic green sheet may satisfy the aforementioned range, which may prevent sheet wrinkle defects or burnt.

Next, an internal electrode pattern may be formed on the ceramic green sheet GS. The internal electrode pattern may be sintered to form internal electrodes 221 and 222. The internal electrode pattern may be formed by printing a conductive paste for internal electrodes including metal powder particles, and a binder at a predetermined thickness on the ceramic green sheet GS using a screen-printing method or a gravure printing method. The metal powder particles may include, for example, one or more of Ni, Cu, Pd, Ag, Au, Pt, Sn, W, Ti, and alloys thereof, but the present disclosure is not limited thereto.

Next, the ceramic green sheets GS on which the internal electrode pattern is formed may be stacked and compressed by a predetermined number of layers to form a ceramic stack body. Additionally, in order to form the cover portions 212 and 213 after sintering, a predetermined number of layers of ceramic green sheets GS in which internal electrode patterns are not printed may be stacked on upper and lower portions of the ceramic stack body in a first direction. Meanwhile, the ceramic green sheet GS may be peeled off from the release film 100 before stacking the ceramic green sheet GS.

In an example embodiment, the peeling force when peeling the ceramic green sheet GS from the release film 100 at a peeling angle of 90° may be 35 mN/40 mm or less. More specifically, when peeling the ceramic green sheet GS from the release film 100 at a peeling rate of 300 mm/min and a peeling angle of 90°, the peeling force may be 35 mN/40 mm or less. Accordingly, when peeling the ceramic green sheet GS from the release film 100, defects such as pinholes or wrinkles in the ceramic green sheet GS may be prevented. A lower limit of the peeling force when peeling the ceramic green sheet GS from the release film 100 at a peeling angle of 90° is not particularly limited thereto, but the lower limit thereof may be 10 mN/40 mm or more, 20 mN/40 mm, or 25 mN/40 mm or more in order to implement intended light peeling force or medium peeling force. The peeling force may be measured by the method disclosed herein. Other methods and/or tools appreciated by one of ordinary skill in the art, even if not described in the present disclosure, may be used.

In an example embodiment, a difference between a work function (eV) of the ceramic green sheet GS measured using ultraviolet photoelectron spectroscopy (UPS) and a work function (eV) of the release layer 120 may be ±0.7 eV or less. Other methods and/or tools appreciated by one of ordinary skill in the art, even if not described in the present disclosure, may be used. When the difference between the work functions of the ceramic green sheet GS and the release layer 120 satisfies the aforementioned range, the amount of static electricity generated due to a difference in charging sequence may be reduced, and the peeling force may be reduced.

The ceramic stack body may be cut into a predetermined chip size as needed, but the present disclosure is not limited thereto. Additionally, the binder included in the ceramic stack body or the cut chip may be removed in a binder removal process. The conditions of the binder removal process may vary, depending on the type of binder used and are not particularly limited.

Then, the ceramic stack body may be sintered. Alternatively, the cut chips may be sintered. A sintering temperature is not particularly limited, but may be, for example, 1100° C. or higher and 1300° C. or lower. The ceramic stack body or the cut chip may be sintered to form the body 210 including the dielectric layer 211 and the internal electrodes 221 and 222.

Finally, the external electrodes 231 and 232 may be formed. First, the body 210 may be dipped in a conductive paste including metal powder particles and glass and then sintered, thus forming electrode layers 231a and 232a. In this case, the sintering temperature may be, for example, 700° C. to 900° C.

Next, plating layers 231b and 232b may be formed using an electrolytic plating method and/or an electroless plating method. The plating layers 231b and 232b may improve packaging characteristics and may be plating layers including Ni, Sn, Pd and/or alloys thereof, and may be formed of a plurality of layers. For example, the plating layers 231b and 232b may be formed by sequentially forming a Ni plating layer and a Sn plating layer.

However, the above-described manufacturing method is an example, and the method for manufacturing the multilayer electronic component 200 is not limited to the above-described manufacturing method.

Hereinafter, the configuration of the present disclosure and effects according thereto will be described in more detail through examples and comparative examples. However, the following examples are intended to illustrate the present disclosure in more detail, and it is obvious that the scope of the present disclosure is not limited to the following experimental examples.

### EXAMPLE 1

Melamine and polydimethylsiloxane, the melamine and polydimethylsiloxane were stoichiometrically weighed so that the content of the nitrogen (N) element from the total elements in the release layer was 11 wt % and then added to isopropyl alcohol (IPA) as a solvent. Next, 0.5 wt % of para-toluenesulfonic acid was added as an acid catalyst to the solvent to manufacture a release composition.

The release composition was applied to one surface of a polyester base film, and was cured and heat-treated in a hot air dryer at 120° C. for 1 minute to form a release layer, thus manufacturing a release film. Additionally, the application amount of the release composition was adjusted so that a ratio of a thickness of the release layer to a thickness of a base film after drying and curing was 0.013.

### EXAMPLE 2

A release film was manufactured in the same manner as Example 1 except that the melamine and polydimethylsiloxane were stoichiometrically weighed so that the content of the nitrogen (N) element from the total elements of the release layer was 21.1 wt % and then added to the solvent.

### EXAMPLE 3

A release film was manufactured in the same manner as Example 1 except that the ammeline and polydimethylsiloxane were stoichiometrically weighed so that the content of the nitrogen (N) element from the total elements of the release layer was 20.8 wt % and then added to the solvent.

### EXAMPLE 4

A release film was manufactured in the same manner as Example 1 except that the melam and polydimethylsiloxane were stoichiometrically weighed so that the content of the nitrogen (N) element from the total elements of the release layer was 19.6 wt % and then added to the solvent.

### EXAMPLE 5

A release film was manufactured in the same manner as Example 1 except that the melem and polydimethylsiloxane were stoichiometrically weighed so that the content of the nitrogen (N) element of the total elements of the release layer was 20.9 wt % and then added to the solvent.

### EXAMPLE 6

A release film was manufactured in the same manner as Example 1 except that the melamine and polydimethylsiloxane were stoichiometrically weighed so that the content of the nitrogen (N) element from the total elements of the release layer was 20.9 wt %, and then added to the solvent, and after drying and curing, a ratio of the thickness of the release layer to the thickness of the base film was adjusted to 0.005.

### EXAMPLE 7

A release film was manufactured in the same manner as in Example 6 except that after drying and curing, the ratio of the thickness of the release layer to the thickness of the base film was adjusted to 0.013.

### EXAMPLE 8

A release film was manufactured in the same manner as in Example 6 except that after drying and curing, the ratio of the thickness of the release layer to the thickness of the base film was adjusted to 0.027.

### COMPARATIVE EXAMPLE 1

Only polydimethylsiloxane was added to a solvent. Next, a release composition was prepared by adding 0.5 wt % of platinum (Pt) catalyst to the solvent. A release film was manufactured in the same manner as Example 1 except for the difference.

### COMPARATIVE EXAMPLE 2

A release film was manufactured in the same manner as Example 1 except the melamine and polydimethylsiloxane were stoichiometrically weighed so that the content of the nitrogen (N) element from the total elements of the release layer was 10.1 wt % and then added to the solvent.

### COMPARATIVE EXAMPLE 3

A release film was manufactured in the same manner as Example 1 except the melamine and polydimethylsiloxane were stoichiometrically weighed so that the content of the nitrogen (N) element from the total elements of the release layer was 21.6 wt % and then added to the solvent.

### COMPARATIVE EXAMPLE 4

A release film was manufactured in the same manner as Example 1 except that the ammeline and polydimethylsiloxane were stoichiometrically weighed so that the content of the nitrogen (N) element from the total elements of the release layer was 9.9 wt % and then added to the solvent.

### COMPARATIVE EXAMPLE 5

A release film was manufactured in the same manner as Example 1 except the melam and polydimethylsiloxane were stoichiometrically weighed so that the content of the nitrogen (N) element from the total elements of the release layer was 26.2 wt % and then added to the solvent.

### COMPARATIVE EXAMPLE 6

A release film was manufactured in the same manner as Example 1 except that the melem and polydimethylsiloxane were stoichiometrically weighed so that the content of the nitrogen (N) element of the total elements of the release layer was 29.0 wt % and then added to the solvent.

### COMPARATIVE EXAMPLE 7

A release film was manufactured in the same manner as Example 1 except that the melamine and polydimethylsiloxane were stoichiometrically weighed so that the content of the nitrogen (N) element from the total elements of the release layer was 20.9 wt %, and then added to the solvent, and after drying and curing, a ratio of the thickness of the release layer to the thickness of the base film was adjusted to 0.003.

### COMPARATIVE EXAMPLE 8

A release film was manufactured in the same manner as Comparative Example 7 except that after drying and curing, the ratio of the thickness of the release layer to the thickness of the base film was adjusted to 0.031.

### (Physical Property Evaluation)

### 1. XPS Analysis

Component analysis was performed on the surface of the release layer of the release film using X-ray photoelectron spectroscopy (XPS). After measuring the content of silicon element (at) and the content of nitrogen element content (at %) detected through the XPS analysis, an atomic ratio of nitrogen to silicon (N/Si) is listed in Table 1 below.

### 2. Measurement of Maximum Height Roughness (Rmax)

From the release films manufactured in the examples and the comparative examples, the maximum height roughness (Rmax) was measured using a contact-type 3D surface roughness measuring device (Bruker, ContourX-500 product) based on the ISO 25178 (Geometric Product Specifications (GPS)-Surface texture: areal) standard and listed in Table 1 below.

Additionally, after coating and drying the ceramic slurry on the release layer of the release film of the examples and the comparative examples to form a ceramic green sheet, the maximum height roughness (Rmax) of the ceramic green sheet was measured using the same method.

### 3. Measurement of Surface Energy

After dropping distilled water and methylene iodide (Diiodomethane) on the surface of the release layer of the release film manufactured in the examples and comparative examples, a contact angle of a droplet formed on the surface of the release layer was measured using a contact angle measuring device (Phoenix300Touch product). The measured contact angle values were substituted into the Owens-Wendt model to calculate the surface energy and are listed in Table 1 below.

### 4. Measurement of Work Function

A difference in work function between the release layer of the release film manufactured in the examples and the comparative examples and the ceramic green sheet was measured using ultraviolet photoelectron spectroscopy (UPS).

First, a sample for measuring the work function was manufactured by spin-coating the release composition manufactured in the examples and the comparative examples on a conductive glass substrate on which a glass layer and an ITO layer were sequentially stacked. Then, the work function of the release layer was measured through the UPS analysis.

Next, the ceramic slurry was spin-coated on the conductive glass substrate to manufacture a sample for measuring work function, and then, the work function of the ceramic green sheet was measured through the UPS analysis.

Finally, an absolute value of the difference between the work function of the release layer formed from the release composition manufactured in the examples and the comparative examples and the work function of the ceramic green sheet was calculated and is listed in Table 1 below.

### 4. Measurement of Peeling Force

The ceramic slurry was coated and dried on the release layer of the release film of the examples and the comparative examples to form a ceramic green sheet. The peeling force when the ceramic green sheet manufactured with a width of 40 mm and a length of 100 mm was peeled from the release film at a peeling rate of 300 mm/min and a peel angle of 90 was measured using a peeling force measuring device and is listed in Table 1 below.

### 5. Measurement of Electrostatic Force

After coating and drying the ceramic slurry on the release layer of the release film of the examples and the comparative examples to form a ceramic green sheet, the electrostatic amount when peeling the ceramic green sheet from the release film was measured using an electrostatic amount measuring device, and is listed in Table 1 below.

### 6. Measurement of Sheet Wrinkle Defect Rate and Number of Burns

After applying and drying the ceramic slurry on the release films of the examples and the comparative examples to form a ceramic green sheet, the ceramic green sheet was peeled from the release film. A ratio of the ceramic green sheet existing in a folded or wrinkled state in a sample chip in which a plurality of ceramic green sheets were stacked was measured and is listed in Table 1 below.

Additionally, when 20 layers of ceramic green sheets manufactured using the release films of the examples and the comparative examples were stacked, the number of times of occurrence of burnt marks due to the generated static electricity is listed in Table 1 below.

TABLE 1

| | | | | | | | | | | | Sheet | |
|---|---|---|---|---|---|---|---|---|---|---|---|---|
| | | | | | | Work | Release | | Electro- | Green | wrinkle | |
| | Melamine- | Nitrogen | N/Si | | Surface | function | layer | Peeling | static | sheet | defect | |
| | based | content | atomic | Thickness | energy | difference | Rmax | force | force | Rmax | rate | Burnt |
| Division | compound | (wt %) | ratio | ratio | (mN/m) | (eV) | (nm) | (mN/40 mm) | (kV) | (nm) | (ppm) | Number |
| Example 1 | Melamine | 11 | 0.61 | 0.013 | 28.1 | 0.5 | 63 | 29.4 | 1.4 | 51 | 200 | 2 |
| Example 2 | Melamine | 21.1 | 1.07 | 0.013 | 30.0 | 0.4 | 60 | 30.1 | 1.7 | 48 | 300 | 3 |
| Example 3 | Ammeline | 20.8 | 1.06 | 0.013 | 29.0 | 0.5 | 61 | 30.0 | 1.3 | 48 | 300 | 2 |
| Example 4 | Melam | 19.6 | 1.00 | 0.013 | 28.7 | 0.7 | 62 | 30.5 | 0.9 | 49 | 400 | 4 |
| Example 5 | Melem | 20.9 | 1.05 | 0.013 | 28.9 | 0.7 | 63 | 30.5 | 0.8 | 49 | 400 | 2 |
| Example 6 | Melamine | 20.9 | 1.06 | 0.005 | 29.0 | 0.6 | 68 | 30.5 | 1.1 | 53 | 200 | 2 |
| Example 7 | Melamine | 20.9 | 1.07 | 0.013 | 29.7 | 0.6 | 60 | 29.9 | 1.0 | 50 | 300 | 1 |
| Example 8 | Melamine | 20.9 | 1.06 | 0.027 | 29.7 | 0.6 | 52 | 33.8 | 0.7 | 50 | 200 | 4 |
| Comparative | — | 0.0 | 0.00 | 0.013 | 31.5 | 1.4 | 67 | 39.6 | 14.8 | 54 | 5000 | 50 |
| Example 1 | | | | | | | | | | | | |
| Comparative | Melamine | 10.1 | 0.51 | 0.013 | 26 | 0.8 | 61 | 43.2 | 13.3 | 56 | 2500 | 17 |
| Example 2 | | | | | | | | | | | | |
| Comparative | Melamine | 21.6 | 1.11 | 0.013 | 32 | 0.6 | 61 | 40.1 | 12.4 | 57 | 2000 | 14 |
| Example 3 | | | | | | | | | | | | |
| Comparative | Ammeline | 9.9 | 0.50 | 0.013 | 28.4 | 1.1 | 62 | 37.8 | 12 | 55 | 3000 | 30 |
| Example 4 | | | | | | | | | | | | |
| Comparative | Melam | 26.2 | 1.33 | 0.013 | 35 | 4.5 | 63 | 39.2 | 13.1 | 57 | 3500 | 30 |
| Example 5 | | | | | | | | | | | | |
| Comparative | Melem | 29.0 | 1.47 | 0.013 | 37 | 4.3 | 61 | 42.0 | 13.0 | 58 | 3500 | 32 |
| Example 6 | | | | | | | | | | | | |
| Comparative | Melamine | 20.9 | 1.06 | 0.003 | 31 | 4.0 | 121 | 35.0 | 12.9 | 67 | 2000 | 18 |
| Example 7 | | | | | | | | | | | | |
| Comparative | Melamine | 20.9 | 1.06 | 0.031 | 32 | 3.5 | 55 | 44.0 | 12.5 | 48 | 1500 | 15 |
| Example 8 | | | | | | | | | | | | |

Referring to Table 1, it may be confirmed that the atomic ratio of nitrogen to silicon (N/Si) satisfies 0.6 or more and 1.1 or less, by which the release films manufactured in Examples 1 to 8 have excellent peelability and excellent antistatic properties as compared to the release films manufactured in Comparative Examples 1 to 8. From this, it may be seen that the release films manufactured in Examples 1 to 8 are suitable for a manufacturing process of a multilayer electronic component, especially MLCC.

The present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

Additionally, the expression an example embodiment′ used in the present disclosure does not denote the same example embodiment, and is provided to emphasize and explain different unique characteristics. However, the example embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

What is claimed is:

1. A release film, comprising:
a base film; and
a release layer disposed on a first surface of the base film,
wherein the release layer includes a cured product of a release composition including a heterocyclic compound including nitrogen and polydimethylsiloxane, and
when analyzing a surface of the release layer using X-ray photoelectron spectroscopy (XPS), the release layer has an atomic ratio of nitrogen (N) to silicon (Si) (N/Si) of 0.6 to 1.1.

2. The release film according to claim 1, wherein a maximum height roughness (Rmax) of the release layer is 70 nm or less.

3. The release film according to claim 1, wherein a ratio of a thickness of the release layer to a thickness of the base film is 0.005 or more and 0.027 or less.

4. The release film according to claim 1, wherein a surface energy of the release layer is 28 mN/m or more and 30 mN/m or less.

5. The release film according to claim 1, wherein the heterocyclic compound includes one or more selected from melamine, ammeline, melam, and melem.

6. The release film according to claim 1, wherein the heterocyclic compound includes one or more selected from ammeline, melam, and melem.

7. The release film according to claim 1, wherein the release composition further includes para-toluenesulfonic acid.

8. The release film according to claim 1, further comprising:
an antistatic layer disposed on a second surface of the base film, wherein the second surface opposes the first surface.

9. The release film according to claim 1, wherein the release layer is the cured product of the release composition.

10. The release film according to claim 9, wherein a ratio of a thickness of the release layer to a thickness of the base film is 0.005 or more and 0.027 or less,
a surface energy of the release layer is 28 mN/m or more and 30 mN/m or less, and
a maximum height roughness (Rmax) of the release layer is 70 nm or less.

11. The release film according to claim 10, wherein the heterocyclic compound includes melamine.

12. The release film according to claim 10, wherein the heterocyclic compound includes ammeline.

13. The release film according to claim 10, wherein the heterocyclic compound includes melam.

14. The release film according to claim 10, wherein the heterocyclic compound includes melem.

15. The release film according to claim 1, wherein a content of polydimethylsiloxane included in the release composition is 3 parts by weight or more and 25 parts by weight or less based on a total of 100 parts by weight of the heterocyclic compound and polydimethylsiloxane.

16. A method for manufacturing a multilayer electronic component, the method comprising:
forming a ceramic green sheet by applying a ceramic slurry on the release film of claim 1;
forming an internal electrode pattern on the ceramic green sheet;
forming a ceramic stack body by stacking a plurality of the ceramic green sheet on which the internal electrode pattern is formed; and
sintering the ceramic stack body.

17. The method according to claim 16, further comprising:
peeling the ceramic green sheet from the release film before the stacking of the ceramic green sheet,
wherein, when the peeling of the ceramic green sheet from the release film is performed at a peeling rate of 300 mm/min and a peeling angle of 90°, a peeling force is 35 mN/40 mm or less.

18. The method according to claim 16, wherein a difference between a work function (eV) of the ceramic green sheet and a work function (eV) of the release layer measured using ultraviolet photoelectron spectroscopy (UPS) is +0.7 eV or less.

19. The method according to claim 16, wherein an average thickness of the ceramic green sheet is 0.5 μm to 5.0 μm.
